(19) United States
(12) Patent Application Publication
(10) Pub. No.: US 2009/0301837 A1
(43) Pub. Date: Dec. 10, 2009

(54) BI-DIRECTIONAL ESCALATOR

(76) Inventor: Jianwei Zhang, Zhejiang Province (CN)

Correspondence Address: CARLSON GASKEY & OLDS, 400 W MAPLE STE 350, BIRMINGHAM, MI, 48009, US

(21) Appl. No.: 12/301,288

(22) PCT Filed: May 18, 2007
(86) PCT No.: PCT/CN07/01621

§ 371 Date: Jul. 9, 2009

(30) Foreign Application Priority Data
May 18, 2006 (CN) 200610050801.4
May 18, 2006 (CN) 200620103737.7

(51) Int. Cl. B66B 23/02

(52) U.S. Cl. 198/330

(57) ABSTRACT

A bi-directional escalator with an integrate framework is disclosed. It consists of a first escalator including a first driver having a first drive shaft; a second escalator including a second driver having a second drive shaft; and a two-stage bevel gear reversing unit. The two-stage bevel gear reversing unit includes: a first bevel gear connected to the first drive shaft, a second bevel gear connected to the second drive shaft, a third bevel gear engaged with the first bevel gear and the second bevel gear, and a main driving machine which drives the first escalator and the second escalator simultaneously by means of the two-stage bevel gear reversing unit. The invention is good design, low cost and energy saving.

### TECHNICAL FIELD

The present invention pertains to an escalator. In particular, the present invention pertains to a bi-directional escalator that uses a single main driving apparatus consisting of a group of driving apparatuses to drive two parallel bi-directional escalators.

### PRIOR ART

A bi-directional escalator typically comprises an ascending escalator and a descending escalator that are arranged essentially in parallel with each other. Both the ascending escalator and the descending escalator include a frame, steps, handrails, and a driving apparatus.

All bi-directional escalators having two parallel escalators currently available are realized by arranging two single escalators side by side. Each escalator has its own main driving unit. Therefore, the problems of the conventional escalator include complicated structure, high manufacturing cost, and wasted energy.

### CONTENT OF THE INVENTION

The technical problem to be solved by the present invention is to provide a bi-directional escalator, wherein the two escalators are driven by a single main driving unit.

According to one aspect of the present invention, the present invention provides a bi-directional escalator including a first escalator having a first escalator driving apparatus with a first driving shaft and a second escalator having a second escalator driving apparatus with a second driving shaft. The bi-directional escalator also includes a two-stage bevel gear reversing unit having a first bevel gear that is connected to said first driving shaft, a second bevel gear that is connected to the second driving shaft, and a third bevel gear that is engaged with the first and second bevel gears. A main driving apparatus drives the first and second escalators at the same time using the two-stage bevel gearing reversing unit.

In the illustrative embodiment, the first escalator driving apparatus includes two step chain sprockets connected to the two ends of the first driving shaft and a brake disk connected to one of said two step chain sprockets. Similarly, the second escalator driving apparatus includes two step chain sprockets connected to the two ends of the second driving shaft and a brake disk connected to one of said two step chain sprockets.

The main driving apparatus includes a driving chain, a driving sprocket that is connected to one of the step chain sprockets of the first escalator driving apparatus and of the second escalator driving apparatus, and a main unit connected to said driving sprocket via the driving chain.

The bi-directional escalator comprising said first and second escalators may have a common frame.

The first bevel gear and the second bevel gear can be connected to the first driving shaft and the second driving shaft via keys, splines, or shaft couplers.

In the illustrative embodiment, said first and second escalators are arranged essentially in parallel with each other, and the first and second escalator driving apparatuses are arranged in parallel with each other.

Also in the illustrative embodiment, the first driving shaft of the first escalator driving apparatus of the first escalator is arranged essentially coaxially with the second driving shaft of the second escalator driving apparatus of the second escalator.

Compared with the prior art, the present invention has the following advantages. The bi-directional escalator of the present invention adds a two-stage bevel gear reversing unit but reduces the set of the main driving apparatus, including the main unit, driving chain, and driving sprocket. The entire driving mechanism is installed in the elevator machine room as with a conventional elevator to drive two escalators at the same time with one main driving apparatus. The structure is compact and simple, the manufacturing and operation costs are low, and it is possible to save energy effectively.

### BRIEF DESCRIPTION OF THE FIGURE

FIG. 1 shows the structure of the present invention.

### DETAILED DESCRIPTION

In the following, the content and application example of the present invention will be explained in more detail based on the attached FIGURE. The same or similar symbols in the FIGURE represent the same or similar parts, respectively. The following explanation of the present invention based on the attached FIGURE is only intended to illustrate and describe one embodiment of the present invention, and should not be interpreted as a limitation on the scope of the present invention.

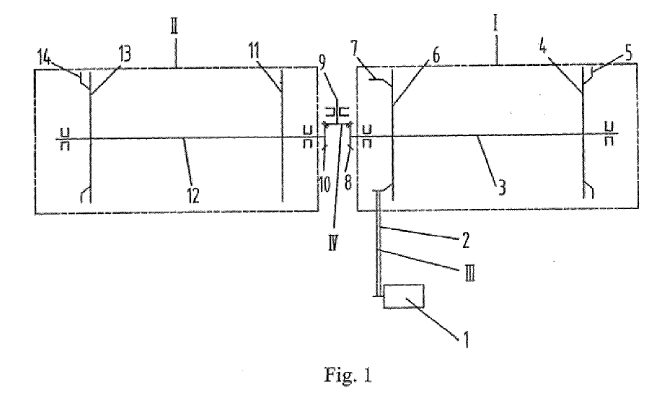

As shown in FIG. 1, in this application example, the bi-directional escalator comprises a first escalator including a first escalator driving apparatus I having a first driving shaft 3; a second escalator including a second escalator driving apparatus II having a second driving shaft 12; a two-stage bevel gear reversing unit IV; and a main driving apparatus III that drives the first and second escalators at the same time through two-stage bevel gear reversing unit IV.

The two-stage bevel gear reversing unit IV includes a first bevel gear 8 connected to the first driving shaft 3, a second bevel gear 10 connected to the second driving shaft 12, and a third bevel gear 9 engaged with both the first bevel gear 8 and the second bevel gear 10.

In the embodiment shown in FIG. 1, the first and second escalators constitute a bi-directional escalator that uses a common frame.

The first and second escalators can be arranged essentially in parallel with each other. In addition, the first and second escalator driving apparatuses can be arranged in parallel with each other.

The first driving shaft 3 of the first escalator driving apparatus I of the first escalator is arranged essentially coaxially with the second driving shaft 12 of the second escalator driving apparatus II of the second escalator.

It should be pointed out that the first and second escalators, the first and second escalator driving apparatuses, and the first driving shaft of the first escalator driving apparatus of the first escalator and the second driving shaft of the second escalator driving apparatus of the second escalator can have any configuration using any appropriate methods without being limited by the aforementioned arrangements, as long as the first driving shaft of the first escalator driving apparatus and the second driving shaft of the second escalator driving apparatus can be connected through the first bevel gear 8, the second bevel gear 10, and the third bevel gear 9 so that the main driving apparatus III can drive the first and second escalators at the same time via two-stage bevel gear reversing unit IV. For example, the first driving shaft of the first escalator driving apparatus of the first escalator and the second driving shaft of the second escalator driving apparatus of the second escalator can be arranged at an angle close to 180° instead of being arranged coaxially. In one possible embodiment according to this example, the first and second escalators can cross each other approximately at the central position, with the first escalator driving apparatus of the first escalator and the second escalator driving apparatus of the second escalator installed at a central position so that the first driving shaft of the first escalator driving apparatus of the first escalator and the second driving shaft of the second escalator driving apparatus of the second escalator can be connected through the first bevel gear 8, the second bevel gear 10, and the third bevel gear 9.

The first escalator driving apparatus I of the first escalator includes a first right step chain sprocket 4 and a first left step chain sprocket 6 connected to the two ends of the first driving shaft 3, and a first brake disk 5 that is connected to the first right step chain sprocket 4, as shown for example in FIG. 1, or to the first left step chain sprocket 6. Similarly, the second escalator driving apparatus II of the second escalator includes a second right step chain sprocket 11 and a second left step chain sprocket 13 connected to the two ends of the second driving shaft 12 and a second brake disk 14 that is connected to the second right step chain sprocket 11 or to the second left step chain sprocket 13, as shown for example in FIG. 1.

Although the terms “left” and “right” are used in the explanation above, they are only used to facilitate description of the invention and should not be interpreted as limiting the present invention.

The main driving apparatus III can include a driving chain 2 and a driving sprocket 7 that is connected to one of the first right step chain sprocket 4, the first left step chain sprocket 6 (as shown, for example, in FIG. 1), the second right step chain sprocket 11, and the second left step chain sprocket 13. Main driving apparatus III also includes main unit 1 connected to the driving sprocket 7 via the driving chain 2. Main unit 1 can also include an electric motor (not shown) and a decelerator connected to the electric motor (not shown).

The first bevel gear 8 and second bevel gear 10 can be connected to the first driving shaft 3 and the second driving shaft 12 via keys, splines, or shaft couplers. The first bevel gear 8 and second bevel gear 10 can realize two-stage reversing drive via the engagement with the third bevel gear 9. The third bevel gear 9 and the first bevel gear 8 realize the first-stage reversing drive, while the second bevel gear 10 and the third bevel gear 9 realize the second-stage reversing drive.

In the embodiment described above, main unit 1 drives the first escalator driving apparatus I and the second escalator driving apparatus II through driving chain 2 and the driving sprocket 7 fixed on the first left step chain sprocket 6. The present invention, however, is not limited to this configuration. For example, the main unit can be connected via a shaft coupler to the first driving shaft 3 of the first escalator driving apparatus, the second driving shaft 12 of the second escalator driving apparatus, or the shaft of the third bevel gear 9.

By adding a two-stage bevel gear reversing unit IV between the first escalator driving apparatus I and the second escalator driving apparatus II that are typically independent from each other in two parallel escalators, the present invention enables using one main driving apparatus III to drive parallel first escalator driving apparatus I and second escalator driving apparatus II at the same time. The steps and the step chains moving in two directions in the bi-directional escalator are independent from each other and are driven by the first left step chain sprocket 6 and the first right step chain sprocket 4 in the first escalator driving apparatus I as well as by the second left step chain sprocket 13 and the second right step chain sprocket 11 in the second escalator driving apparatus II, respectively.

During operation, main unit 1 drives the first escalator driving apparatus I to rotate in one direction through driving chain 2. After finishing two-stage reversing through two-stage bevel gear reversing unit IV, the first escalator driving apparatus I drives the second escalator driving apparatus II to rotate in the opposite direction to realize the purpose of driving two parallel escalators at the same time with one main driving apparatus III.

Although the present invention has been explained in detail based on the aforementioned embodiment and with reference to the attached FIGURE, it is clear to those skilled in the art that the aforementioned technical scheme of the present invention can be modified, changed, and varied in many ways.

1. A bidirectional escalator comprising:
a first escalator including a first escalator driving apparatus having a first driving shaft;
a second escalator including a second escalator driving apparatus having a second driving shaft;
a two-stage bevel gear reversing device, including:
a first bevel gear connected to said first driving shaft,
a second bevel gear connected to said second driving shaft, and
a third bevel gear engaged with the first bevel gear and the second bevel gear; and
a main driving apparatus that drives the first and second escalators at the same time through said two-stage bevel gear reversing device.

2. The bidirectional escalator described in claim 1, wherein:
the first escalator driving apparatus of the first escalator includes two step chain sprockets connected to the two ends of the first driving shaft, and a brake disk connected to one of said two step chain sprockets; and
the second escalator driving apparatus of said second escalator includes two step chain sprockets connected to the two ends of the second driving shaft, and a brake disk connected to one of said two step chain sprockets.

3. The bi-directional escalator described in claim 2, wherein main driving apparatus includes a driving chain, a driving sprocket connected to one of the step chain sprockets of the first escalator driving apparatus or one of the step chain sprockets of the second escalator driving apparatus, and
a main unit connected to said driving sprocket via the driving chain.

4. The bi-directional escalator described in claim 1, wherein
said first and second escalators constitute the bi-directional escalator.

5. The bi-directional escalator described in claim 1, wherein the first bevel gear and the second bevel gear are connected to the first driving shaft and the second driving shaft by at least one of keys, splines, or shaft couplers.

6. The bidirectional escalator described in claim 1, wherein said first and second escalators are arranged in parallel with each other.

7. The bidirectional escalator described in claim 1, wherein the first escalator driving apparatus and second escalator driving apparatus are in parallel with each other.

8. The bidirectional escalator described in claim 1, wherein the first driving shaft of the first escalator driving apparatus of the first escalator is arranged essentially coaxially with the second driving shaft of the second escalator driving apparatus of the second escalator.
